(19) United States
(12) Patent Application Publication
(10) Pub. No.: US 2006/0195559 A1
(43) Pub. Date: Aug. 31, 2006

(54) Services for grid computing

(75) Inventors: Stephen C. Winter, London (GB); Tamas Kiss, London (GB); Gabor Terstyanszky, Middlesex (GB); Peter Kacsuk, Budapest (HU); Thierry M. Delaitre, London (GB); Hector A. Goyeneche, London (GB)

Correspondence Address: NIXON & VANDERHYE, PC, 901 NORTH GLEBE ROAD, 11TH FLOOR, ARLINGTON, VA, 22203, US

(73) Assignee: University of Westminster, London (GB)

(21) Appl. No.: 11/066,552

(22) Filed: Feb. 28, 2005

(51) Int. Cl. G06F 15/173

(52) U.S. Cl. 709/223

(57) ABSTRACT

A Grid management service for deploying legacy code applications on the Grid, without modification of the legacy code, the service having a three layer architecture that is adapted to sit on existing standardised Grid architectures, comprising a front end layer for permitting selection of a desired legacy code application, and for creating a legacy code instance in response to the selection; a resource layer, for defining a legacy code job environment; and a back end layer, for submitting a job for said desired legacy code application, together with information relating to said job environment, for submission to a job manager that arranges for said job to be executed on Grid resources.

### FIELD OF THE INVENTION

The present invention relates to grid computing, in which a distributed network of computers is employed, and in particular to a means of providing services over a grid network.

### BACKGROUND ART

Grid computing (or the use of a computational grid) may be regarded as the application of the resources of many computers in a network to a single problem at the same time—usually to a scientific or technical problem that 10 requires a great number of computer processing cycles or access to large amounts of data. The computational Grid aims to facilitate flexible, secure and coordinated resource sharing between participants. In a Grid computing environment many different hardware and software resources have to work together seamlessly. A specific architecture and protocols have been defined for the Grid, and are explained for example in Foster et al “The Anatomy of the Grid—enabling scalable virtual organisations”—http://www.globus.org/research/papers/anatomy.pdf.

Referring to FIGS. 7 to 9, FIG. 7 shows the layered Grid architecture and its relationship to the Internet protocol architecture. Because the Internet protocol architecture extends from network to application, there is a mapping from Grid layers into Internet layers. The Grid Fabric layer provides the resources to which shared access is mediated by Grid protocols: for example, computational resources, storage systems, or network resources such as a distributed file system, computer cluster, or distributed computer pool. The Connectivity layer defines core communication and authentication protocols required for Grid-specific network transactions. for exchange of data between Fabric layer resources. These protocols are usually drawn from the TCP/IP protocol stack. The Resource layer builds on Connectivity layer communication and authentication protocols to define protocols for the secure negotiation, initiation, monitoring, control, accounting, and payment of sharing operations on individual resources. While the Resource layer is focused on interactions with a single resource, the Collective layer in the architecture contains protocols and services that are not associated with any one specific resource but rather are global in nature and capture interactions across collections of resources: for example: Directory services, Co-allocation, scheduling, and brokering services. FIG. 8 shows Collective and Resource layers can be combined in a variety of ways to deliver functionality. The final layer in the Grid architecture comprises the user applications, and FIG. 9 illustrates an application programmer's view of Grid architecture. Applications are constructed in terms of, and by calling upon, services defined at any layer. At each layer, there are protocols to provide access to a service: resource, e.g. management, data access. At each layer, Application Protocol Interfaces (APIs) may be defined, implemented by Software Development Kits (SDKs), which in turn use Grid protocols to interact with network services that provide capabilities to the end user.

Terms and Standards

Grid systems are represented by the OGSA (Open Grid Services Architecture) see I. Foster, C. Kesselman, J. M. Nick, S. Tuecke. “The Physiology of the Grid An Open Grid Services Architecture for Distributed Systems Integration” http://www.globus.org/research/papers/ogsa.pdf;

WSRF (Web Services Resource Framework) is a standard proposal for implementing OGSA: K. Czajkowski, D. Ferguson, I. Foster, J. Frey, S. Graham, T. Maguire, D. Snelling, S. Tuecke. “From Open Grid Services Infrastructure to WS-Resource Framework: Refactoring and Evolution Version 1.11” May, 2004, http://www-106.ibm.com/developerworks/library/ws-resource/ogsi_to_wsrf_{—}1.0.pdf.

OGSA is represented by the standard OGSI (Open Grid Services Infrastructure), S. Tuecke et al: Open Grid Services Infrastructure (OGSI) Version 1.0, June 2003, http://www.globus.org/research/papers/Final_OGSI_Specification_V1.0.pdf, and

GT3, is a reference implementation of OGSI, see Globus Team, Globus Toolkit, http:H/www.globus.org, and GT4 is a reference implementation of WSRF;

Resource Specification Language (RSL) provides a common interchange language to describe resources. The various components of the Globus Resource Management architecture manipulate RSL strings to perform their management functions in cooperation with the other components in the system.: see http://www.globus.org/gram/rsl_spec1.html

WSDL—Web Services Description Language (WSDL) (see Web Services Description Language (WSDL) Version 1.2, http://www.w3.org/TR/wsdl12). WSDL represents the service description layer within a Web service protocol stack for specifying a public interface for a web service.

Condor—A job manager—see D. Thain, T. Tannenbaum, and M. Livny, “Condor and the Grid”, in Fran Berman, Anthony J. G. Hey, Geoffrey Fox, editors, “Grid Computing: Making The Global Infrastructure a Reality”, John Wiley, 2003

Legacy Code

Grid resources can include legacy code programs that were originally implemented to be run on single computers or on computer clusters. Many large industrial and scientific applications are available today that were written well before Grid computing or service-oriented architectures appeared. One of the biggest obstacles in the widespread industrial take-up of Grid technology is the existence of a large amount of legacy code that is not accessible as Grid services. The deployment of these programs in a Grid environment can be very difficult and usually require significant re-engineering of the original code. To integrate these legacy code programs into service-oriented Grid architectures with the smallest possible effort and best performance, is a crucial point in more widespread industrial take-up of Grid technology.

There are several research efforts aiming at automating the transformation of legacy code into a Grid service. Most of these solutions are based on the general framework to transform legacy applications into Web services outlined in D. Kuebler, and W. Eibach, Adapting legacy applications as Web services, IBM Developer Works, http:H/www-106.ibm.com/developerworks/webservices/library/ws-legacy, and use Java wrapping in order to generate stubs automatically. One example for this is presented in Y. Huang, I. Taylor, D. Walker, and R. Davies, Wrapping Legacy Codes for Grid-Based Applications, in Proceedings of the 17th International Parallel and Distributed Processing Symposium (Workshop on Java for HPC), 22-26 Apr. 2003, Nice, France. where the authors describe a semi-automatic conversion of legacy C code into Java using JNI (Java Native Interface). After wrapping the native C application with the JACAW (Java-C Automatic Wrapper) tool, MEDLI (MEdiation of Data and Legacy Code Interface) is used for data mapping in order to make the code available as part of a Grid workflow. Such Java wrapping requires the user to have access to the source code. To implement a particular wrapper for grid-enabling, it is necessary to acquire a subset of code semantics and these are extracted from the source code itself. Current approaches are based on the information expressed in certain sections of the code (typically known as the header file). In well-formed code, the relevant information is expected to be located in the header file. In practice this is not always the case—crucial information can be buried or “hard-coded” in the body of the source code, and cannot easily be located. An example of this problem is in the specification of file location for file parameters. This is a major shortcoming of the approach.

A different approach from wrapping is presented in T. Bodhuin, and M. Tortorella, Using Grid Technologies for Web-enabling Legacy Systems, in Proceedings of the Software Technology and Engineering Practice (STEP), The workshop Software Analysis and Maintenance: Practices, Tools, Interoperability, September 1921, 2003, Amsterdam, The Netherlands, http://www.bauhaus-stuttgart.de/sam/bodhuin.pdf;. This describes an approach to deal with non-decomposable legacy programs using screen proxies and redirecting input/output calls. However, this solution is language dependant and requires modification of the original code. B. Balis, M. Bubak, and M. Wegiel, A Framework for Migration from Legacy Software to Grid Services, In Cracow Grid Workshop 03, Cracow, Poland, December 2003, http://www.icsr.agh.edu.pl/balis/bib/legacy-cgw03.pdf. describes a framework devised specifically for adaptation of legacy libraries and applications to Grid services environments. However, this describes a very high level conceptual architecture and does not give a generic tool to do the automatic conversion nor propose a specific implementation.

### SUMMARY OF THE INVENTION

It is an object of the present invention to provide a high-level Grid application environment where the end-users can easily and conveniently create complex Grid applications.

It is an object of the present invention to provide a high-level Grid application environment where the end-users can apply any legacy code as a standards compliant Grid service when they create Grid applications.

In a first aspect, the invention provides a Grid management service for deploying legacy code applications on the Grid, the service comprising:

selection means for permitting selection of a desired legacy code application,

process means for creating a legacy code instance in response to said selection;

environment means for defining a legacy code job environment; and

submission means for submitting a job for said desired legacy code application, together with information relating to said job environment, for submission to a job management means that arranges for said job to be executed on Grid resources.

In a second aspect, the invention provides a method of providing legacy code applications as a Grid Service, the method comprising:

selecting a desired legacy code application, and creating, in response to the selection, a legacy code process instance;

defining a legacy code job environment, and

submitting a job for said desired legacy code application, together with information relating to said job environment, for submission to a job management means that arranges for said job to be executed on Grid resources.

The present invention provides a Grid environment where users are able to access predefined Grid services. More than that, users are not only capable of using such services but they can dynamically create and deploy new services in a convenient and efficient way. The present invention provides a means to deploy legacy codes as Grid services without modifying the original code. The present invention may be easily ported into WSRF Grid standards

In at least a preferred embodiment, the invention operates on the binary code, rather than the source code. It is therefore completely independent of the programming language(s) in which the code was originally developed, and pre-empts the need for any language-based intervention. The subset of code semantics necessary to implement grid-enabled version of a particular code is essentially the specification of input and output parameters, based on the use of the application. This may be documented (e.g. the user manual) or undocumented (e.g. derived from user experience). The specification of input/output includes the format and location of the parameters.

By its very nature, the specification of the input/output parameters is implicitly user-controlled. This has the advantage that the user can choose to deliberately limit the usability of the code when it is published as a grid service.

The invention, at least in a preferred embodiment, incorporates security methods for authentication and authorisations. It also incorporates mechanisms for implementing “statefulness” of the generated grid service. Specifically, it creates persistent instances of the service, each with their own state, for each call of the service.

The present invention offers a front-end Grid service layer that communicates with the client in order to pass input and output parameters, and contacts a local job manager through Globus MMJFS [(Master Managed Job Factory Service)—Globus Team, Globus Toolkit, http://www.globus.org] to submit the legacy computational job. To deploy a legacy application as a Grid service there is no need for the source code and not even for the C header files, in contrast to the prior art. The user only has to describe the legacy parameters in a pre-defined XML format. The legacy code can be written in any programming language and can be not only a sequential but also a parallel PVM (Parallel Virtual Machine) or MPI (Message Passing Interface) code that uses a job manager like Condor where wrapping can be difficult. The present invention can be easily adapted to other service-oriented approaches like WSRF or a pure Web services based solution. The present invention supports decomposable or semi-decomposable software systems where the business logic and data model components can be separated from the user interface.

### BRIEF DESCRIPTION OF THE DRAWINGS

In order that the present invention be better understood, a preferred embodiment will now be described with reference to the accompanying drawings, wherein:

FIG. 1 is a schematic block diagram of the conceptual architecture of the present invention;

FIG. 2 is a representation of a legacy code interface description file;

FIG. 3 is a diagram of the interaction between components of the present invention;

FIG. 4 is a representation of a life cycle of the management service of the present invention;

FIG. 5 is a sequence diagram of the life cycle;

FIG. 6 is a detailed representation of the management service of the present invention; and

FIGS. 7 to 9 are representations of the protocol stack for Grid services.

### DESCRIPTION OF THE PREFERRED EMBODIMENTS

The present invention includes a method by which Legacy Code Applications may be transformed into services for the Grid. Throughout the following description, such method is referred to as GEMLCA (Grid Execution Management for Legacy Code Architecture).

The present invention provides a client front-end OGSI Grid service layer that offers a number of interfaces to submit and check the status of computational jobs, and get the results back. The present invention has an interface described in WSDL that can be invoked by any Grid services client to bind and use its functionality through Simple Object Access protocol (SOAP). SOAP is an XML-based protocol for exchanging information between computers (XML is a subset of the general standard language SGML). The general architecture to deploy existing legacy code as a Grid service by means of the present invention is as preferred based on OGSI and GT3 infrastructure but can also be applied to other service-oriented architectures. A preferred embodiment provides the following characteristics:
Offers a set of OGSI interfaces, described in a WSDL file, in order to create, run and manage Grid service instances that offer all the legacy code program functionality.
Interacts with job managers, such as Fork, Condor, PBS or Sun Grid Engine, allocates computing resources, manages input and output data and submits the legacy code program as a computational job.
Administers and manages user data (input and output) related to each legacy code job providing a multi-user and multi-instance Grid service environment.
Ensures that the execution of the legacy code maps to the respective client Grid credential that requests the code to be executed.
Presents a reliable file transfer service to upload or download data from the Grid service master node.
Offers a single sign-on capability for submitting jobs, uploading and downloading data.
A Grid service client can be off-line waiting for compute jobs to be completed, and can request jobs status information and results any time before the GEMLCA instance termination time expires.
Reduces complexity for application developers by adding a software layer to existing OGSI services and by supporting an integrated Grid execution life-cycle environment for multiple users/instances. The Grid execution life cycle includes: upload of data, submission of job, check the status of computational jobs, and get the results back.

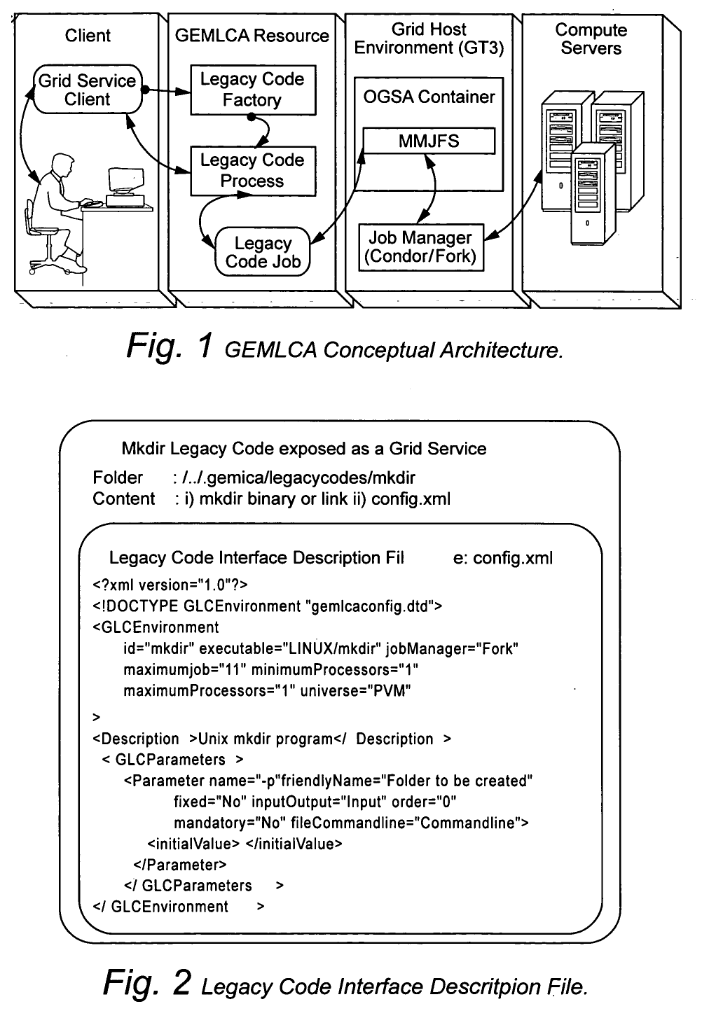

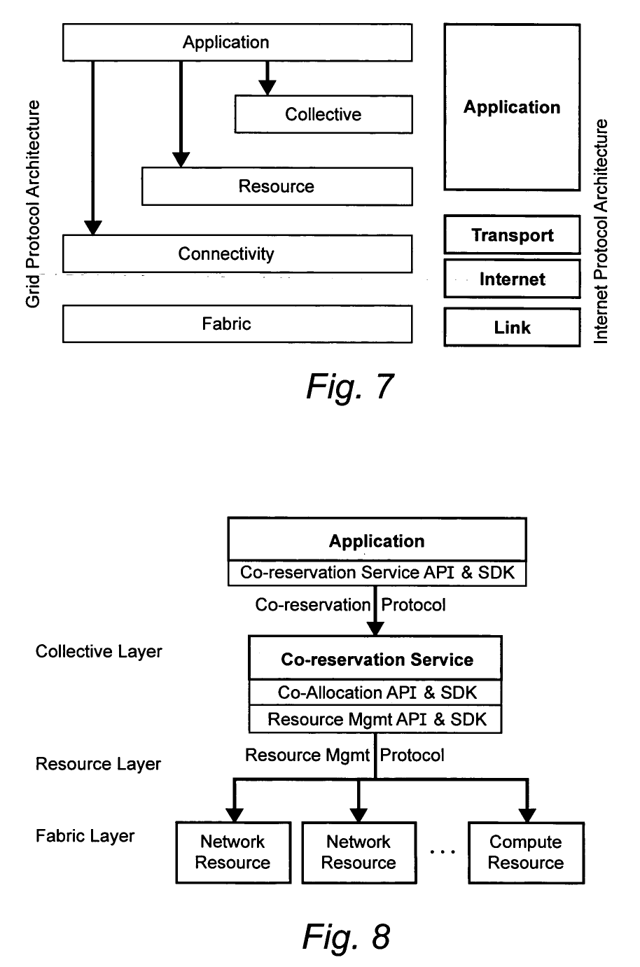

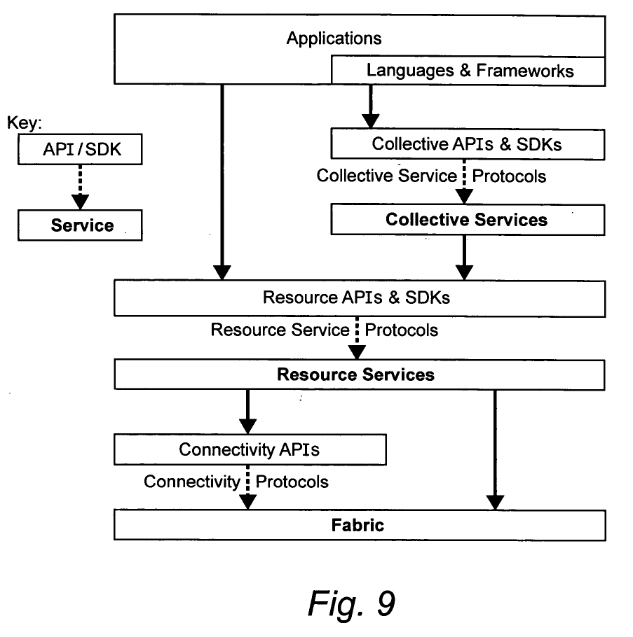

The present invention is a Grid architecture with the main aim of exposing legacy code programs as Grid services without re-engineering the original code and offering a user-friendly interface. The conceptual architecture is shown in FIG. 1, and the architecture is shown specifically in FIG. 6. In FIG. 1, blocks Grid Host Environment (GT3), Compute Servers, correspond roughly to the Connectivity, Fabric layers of FIG. 7. The preferred embodiment of the invention is represented by the GEMLCA Resource block that interacts with the Client block to provide services to the end user. The invention, represented by the GEMLCA Resource block, has a three layer architecture, that is shown specifically in FIG. 6.: the first, front-end layer offers a set of Grid Service interfaces that any authorized Grid client can use in order to contact, run, and get the status and any result back from the legacy code. This layer hides the second, core layer section of the architecture that deals with each legacy code environment and their instances as Grid legacy code processes and jobs. The back end layer, is related to the Grid middleware where the architecture is being deployed. The implementation is based on GT3 but this layer can be updated to any standard, such as WSRF.

In order to access a legacy code program, the user executes a Grid Service client that creates, a legacy code instance with the help of the legacy code factory. Following this, the GEMLCA Resource submits the job to the compute servers through GT3 MMJFS using a job manager, such as Condor.

The invention is composed of a set of Grid services that provides a number of Grid interfaces in order to control the life cycle of the legacy code execution. This architecture can be deployed in several user containers or Tomcat application contexts.

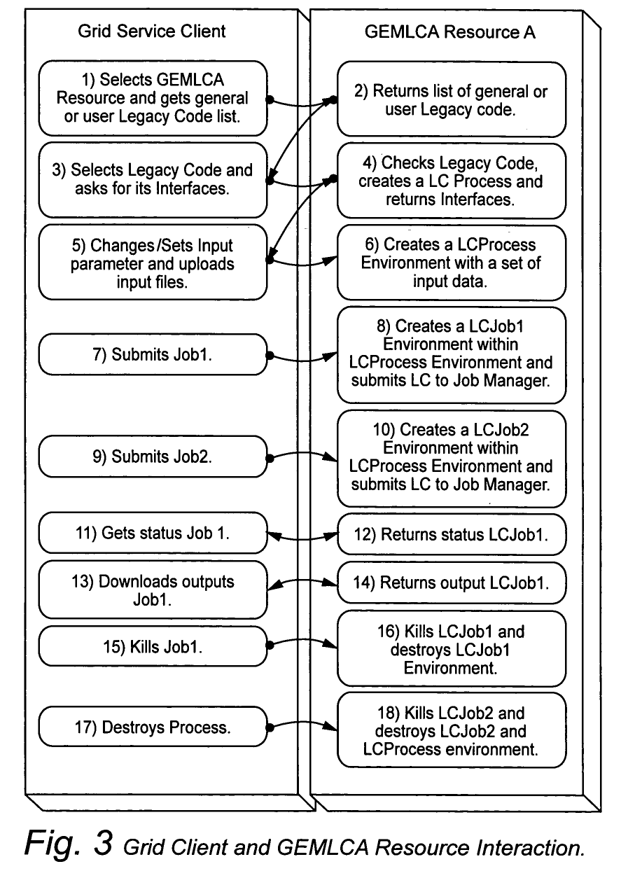

Legacy Code deployment FIG. 2. In the present invention, a Legacy Code Interface Description File (LCID) is created in XML, for each Legacy Code that is to be made available. This is done at the initial setting up or administration stage. This LCID file shown in FIG. 2 consists of three sections. The GLCenvironment section contains the name of the legacy code and its main binary file, job manager (Condor or Fork), maximum number of jobs allowed to be submitted from a single Legacy Code process, and minimum and maximum number of processors to be used. The next section describes the legacy code in simple text format, and finally the parameter section exposes the list of parameters, each one describing its name, friendly name, input or output, order, mandatory, file or command line, fixed, and regular expression to be used as input validation. The process of creating the LCID file may be automated, making it even easier for the end user to deploy legacy applications as Grid services.

Thereafter the XML file is stored and is made available to the Resource when a job is submitted

GEMLCA security and multi-user environment The invention uses the Grid Security Infrastructure (GSI) [J. Gawor, S. Meder, F. Siebenlist, V. Welch, GT3 Grid Security Infrastructure Overview, February 2004. http://www-unix.globus.org/security/.gt3-security-overview.doc] to enable user authentication and to support secure communication over a Grid network. A client needs to sign its credential and also to work in full delegation mode in order to allow the architecture to work on its behalf. There are two levels of authorisation: the first level is given by the grid-map file mechanism [L. Ramakrishnan. Writing secure grid services using Globus Toolkit 3.0. September 2003, http://www-106.ibm.com/developerworks/grid/library/gr-secserv.html]. If the user is correctly mapped, the second level comes into play, which is given by a set of legacy codes that a Grid Client is allowed to use. This set is composed of a combination of a general list of legacy codes, available to anyone using a specific resource, and a user mapped list of legacy codes, only available to Grid clients mapped to a local user by the grid-map file mechanism. The invention administers the internal behaviour of legacy codes taking into account the requirements of input files and output files in a multi-user environment, and also complies with the security restrictions of the operating systems where the architecture is running. In order to do that, The invention uses itself in a protected mode composed of a set of system legacy codes in order to create and destroy a unique process and job stateful environment only reachable by the local user mapped by the grid-map file mechanism.

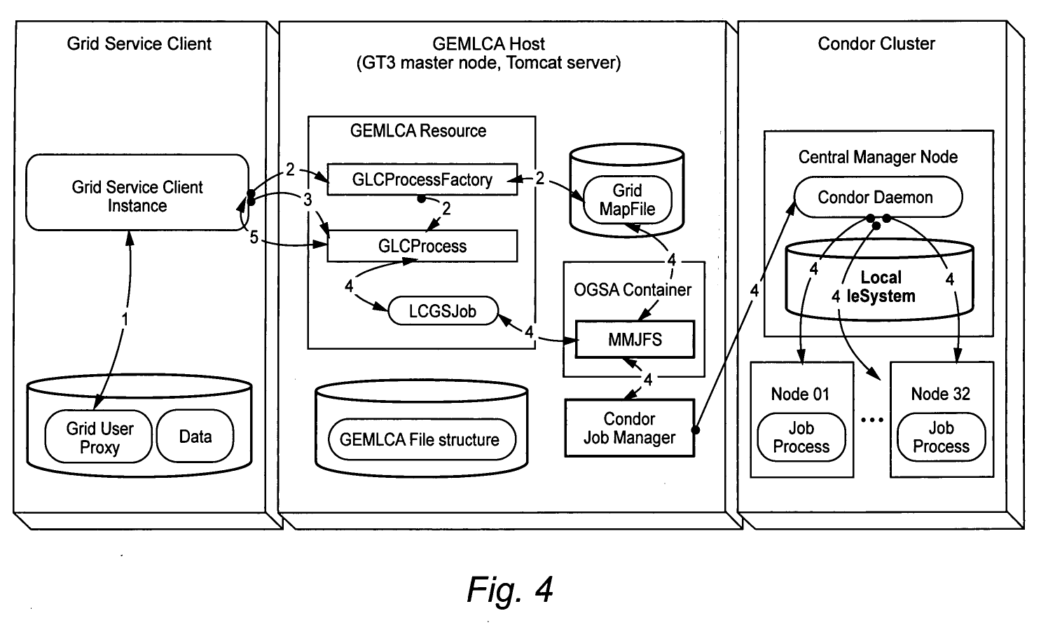

Grid Client interaction with GEMLCA interfaces FIG. 3. FIG. 3 shows the interaction employed by the invention, between a Grid client and a GEMLCA resource exposing Legacy code programs:
1) Selects GEMLCA Resource and gets general or user Legacy Code list.
2) Returns list of general or user Legacy code.
3) Selects Legacy Code and asks for its interfaces.
4) Checks Legacy Code, creates a LCProcess and returns interfaces.
5) Changes/Sets input parameter and uploads input files.
6) Creates a LCProcess Environment (that is a description of legacy code parameters according to the XML file) with a set of input data.
7) Submits Job1.
8) Creates a LCJob1 Environment (this is an instantiation of Process Environment and has state information of what is needed to know about the job) within LCProcess Environment and submits LC to Job Manager.
9) Submits Job2—this is another instance of the legacy code process
10) Creates a LCJob2 Environment within LCProcess Environment and submit LC to Job Manager.
11) Gets status Job 1.
12) Returns status LCjob1.
13) Downloads outputs Job1.
14) Returns output LCjob1.
15) Kills Job 1.
16) kills LCjob1 and destroys LCJob1 Environment.
17) Destroys Process.
18) Kills LCjob2 and destroys LCJob2 and LCProcess environment.
   A unique set of stubs is used by the Grid client in order to interact with any exposed legacy code. When a client selects a legacy code, GEMLCA creates a LCProcess and its stateful environment using the default values, if any, for each input and output parameter. Each LCProcess can be customized to accept a maximum number of LCJobs to be submitted from its interfaces. GEMLCA also provides a set of interfaces for the Grid client in order to query and retrieve the LCProcess status, the list and number of LCJobs in each LCProcess, and the output results of each job. Finally, a particular LCJob can be killed or a LCProcess destroyed.

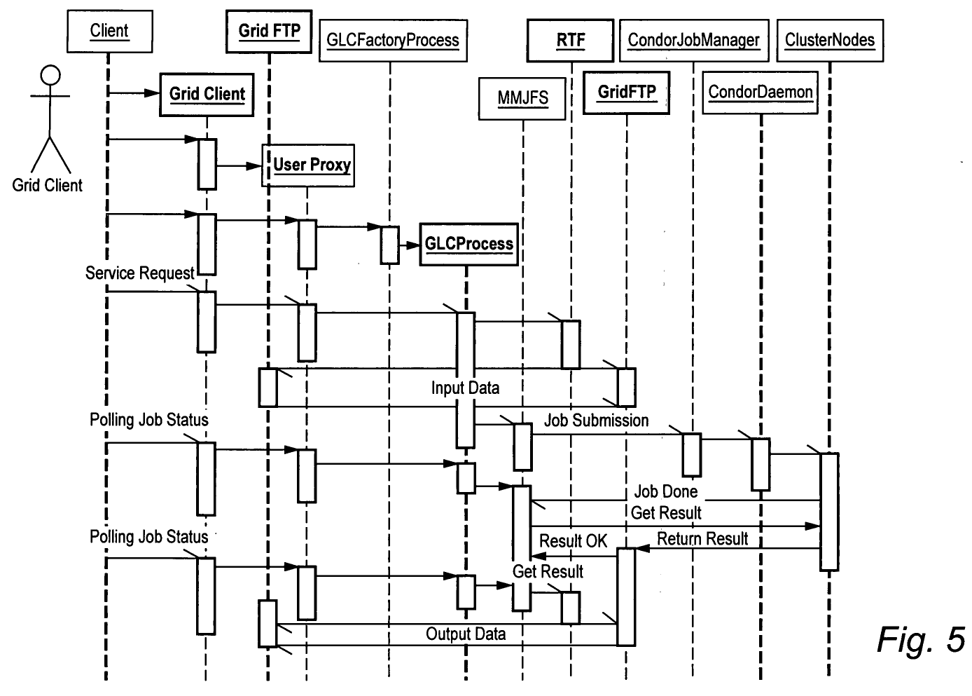

Detailed Description of the Architecture FIGS. 4. 5 and 6:

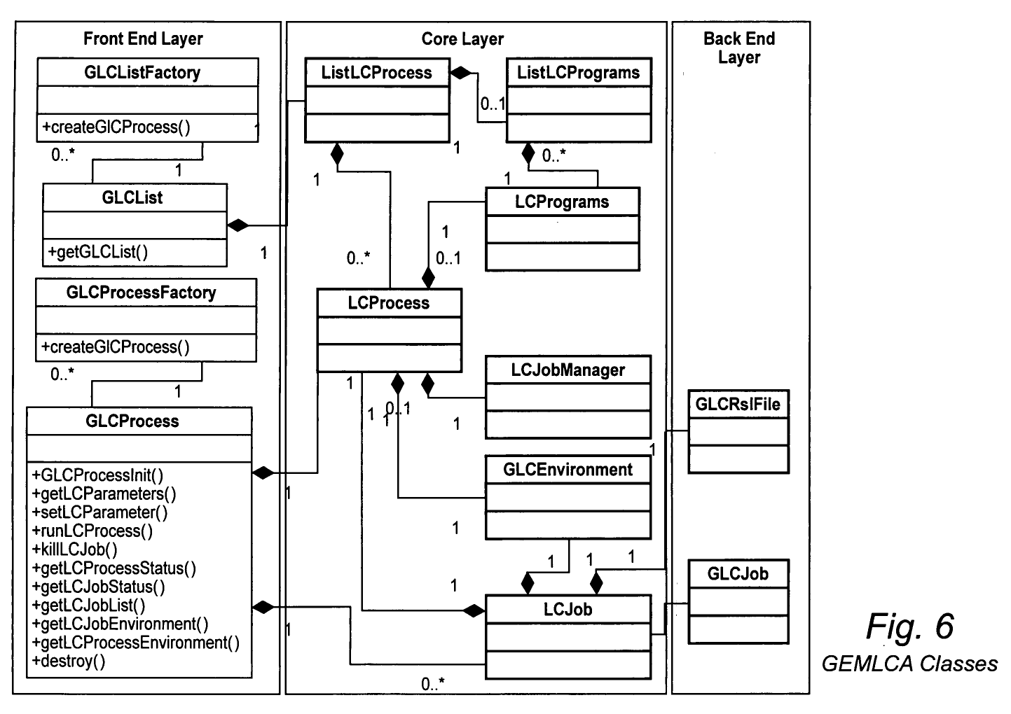

FIGS. 4 and 5 show the implementation of the invention and its life cycle. The Condor management system is used by a computer cluster as the job manager to execute legacy parallel programs. As shown in FIG. 4, the Grid architecture is divided into blocks Grid Service Client, GEMLCA Host, Condor Cluster. The invention is represented by the GEMLCA Resource block, and the GEMLCA File Structure. The arrows 2, 3, 5 correspond generally to the representation in FIG. 3. The scenario for submitting legacy code using the architecture of the invention is composed of the following steps—see the arrows enumerated in FIG. 4.:
(1) The user signs the certificates to create a Grid proxy. The user Grid credential will later be delegated by the GEMLCA Grid services from the client (in a file that accompanies the job) to the Globus Master Managed Job Factory Service (MMJFS) for the allocation of resources.
(2) A Grid service client, using the Grid Legacy Code Process Factory (GLCProcessFactory), creates a Grid Legacy Code Process (GLCProcess) instance where the initial process legacy code environment is set and created using the GEMLCA file structure (FIG. 2).
(3) The Grid Client sets and uploads the input parameters needed by the legacy code program exposed by the GLCProcess and deploys a job using a Resource Specification Language (RSL) file and a multiuser/instance environment to handle input and output data. The RSL file is an XML file defined by the Globus toolkit with parameters of environmental values.
(4) If the client credential is successfully mapped, MMJFS contacts the Condor job manager that allocates resources and executes the parallel legacy code in a computer cluster.
(5) As far as the client credentials are not expired and the GLCProcess is still alive, the client can contact GEMLCA for checking job status and retrieve partial or final results any time.
Finally, when the Grid Service instance is destroyed, the multi-user/instance environment is cleaned.

FIG. 5 summarises the GEMLCA life cycle of the invention on a sequence diagram.

Referring now to FIG. 6, the preferred embodiment of the invention is a three-layer architecture that enables any general legacy code program to be deployed as an OGSA Grid Service. The layers can be introduced as:

The front-end layer called Grid Services Layer is published as a set of Grid Services, which is the only access point for a Grid client to submit jobs and retrieve results from a legacy code program. This layer offers the functionality of publishing legacy code programs already deployed on the master node server. A Grid client can create a GLCProcess and a number of GLCJob per process that are submitted to a job manager. This allows the user extra flexibility by adding the capability of managing several similar instances of the same application using the same Grid service process and varying the input parameters.

The Internal Core Layer is composed of several classes that manage the legacy code program environment and job behaviour.

The GT3 backend Layer that is closely related to Globus Toolkit 3 and offers services to the Internal Layer in order to create a Globus Resource Specification Language file (RSL) [see http://www.globus.org/gram/rsl.html] and to submit and control the job using a specific job manager. This layer essentially extends the classes provided by Globus version 3 offering a standard interface to the Internal Layer. The Layer disconnects the architecture's main core from any third party classes, such as GT3.

More specifically, referring to FIG. 6, GLCList class is one of the front-end layer Grid Services that publishes (by access to the XML files) a list of already deployed and available legacy code programs and their description. There are two types of legacy codes: the “general ones” that are available to anyone with Grid credentials enabled and mapped using gridmap file (a known feature) in the GEMLCA Resource and the “user ones” that are only available to Grid clients mapped to the owner of the legacy code.

Each legacy code is deployed together with a Legacy Code Interface Description File (LCID) (FIG. 2) that contains information related to the legacy code program in XML format, such as the job manager that is able to support this program, minimum and maximum number of processors required and its universe. Also, this file describes the list of parameters and its properties: Name, Friendly name, Input/Output, Order, Mandatory, File or Command Line, Initial Value, Fixed. This configuration file is represented and managed by the GLCEnvironment class.

Using the GLCList Grid Service, a client can retrieve a list of available legacy code programs. A client that meets the security requirements can create a GLCProcess instances invoking the GLCProcessFactory. The factory uses the legacy code configuration file to create and set the default program environment.

A GLCProcess object represents a legacy code process in this architecture. This process cannot be submitted to any job manager if the GLCEnvironment and all the mandatory input parameters have not been created and updated. A client Grid service can submit a job using the default parameters or change any non-fixed parameter before submission. Any time that a process is submitted, a new GLCJob object is created together with a different GLCEnvironment. The process GLCEnvironment gives the maximum number of jobs that a single client can submit within a process. Each job represents a process instance.

The GLCJob uses the GLCEnvironment to create an RSL file using GLCRslFile that is used to submit the legacy code program to a specific job manager.

A Grid Service client can check the general process status or specific job behaviour using the GLCProcess instance. Also, a client can destroy a GLCProcess instance or a specific GLCJob within the process.

Thus FIG. 6 shows that the Front End Layer has the functionalities, firstly to return the available legacy code applications for selection by an end user, and then to set the parameters for the legacy code process. One process may create many jobs. A job is submitted to the core Layer, and results received from the Core layer are passed back to the end user.

The Core layer has the internal administrative functions of setting the environment for a job, and for creating and handling Grid services, and processing instances.

The Back End Layer interacts with the known middleware Connectivity layer, as shown in FIGS. 1 and 4, by passing the job, together with an RSL file describing job parameters.

### EXAMPLE

Urban Car Traffic Simulation

The invention described above was demonstrated by deploying a Manhattan road traffic generator, several instances of the legacy traffic simulator and a traffic density analyzer into Grid services. All these legacy codes were executed from a single workflow and the execution was visualised by a Grid portal. The workflow consists of three types of legacy code components:

1. The Manhattan legacy code is an application to generate MadCity compatible network and turn input-files. The MadCity network file is a sequence of numbers, representing a road topology, of a real road network. The number of columns, rows, unit width and unit height can be set as input parameters. The MadCity turn file, is a sequence of numbers representing the junction manoeuvres available in a given road network. Traffic light details are included in this input file.

2. MadCity [A. Gourgoulis, G. Terstyansky, P. Kacsuk, S. C. Winter, Creating Scalable Traffic Simulation on Clusters. PDP2004. Conference Proceedings of the 12th Euromicro Conference on Parallel, Distributed and Network based Processing, La Coruna, Spain, 11-13th Feb. 2004] is a discrete time-based traffic simulator. It simulates traffic on a road network and shows how individual vehicles behave on roads and at junctions. The simulator of MadCity models the movement of vehicles using the input road network file. After completing the simulation, the simulator creates a macroscopic trace file.

3. A traffic density analyzer, which compares the traffic congestion of several simulations of a given city and presents a graphical analysis.

The workflow was configured to use five GEMLCA resources each one deployed on the UK OGSA test bed sites and one server where the P-GRADE portal is deployed. The first GEMLCA resource is installed at the University of Westminster (UK) and runs the Manhattan road network generator (Job0), one traffic simulator instance (Job3) and the final traffic density analyzer (Job6). Four additional GEMLCA resources are installed at the following sites: SZTAKI (Hungary), University of Portsmouth (UK), The CCLRC Daresbury Laboratory (UK), and University of Reading (UK) where the traffic simulator is deployed. One instance of the simulator is executed on each of these sites, respectively Job1, Job2, Job5 and Job4. The MadCity network file and the turn file are used as input to each traffic simulator instance. In order to have a different behaviour in each of these instances, each one was set with different initial number of cars per street junction, one of the input parameter of the program. The output file of each traffic simulation is used as input file to the Traffic density analyzer. The described workflow was successfully created and executed by the Grid portal installed at the University of Westminster.

1. A Grid management service for deploying legacy code applications on the Grid, the service comprising:
selection means for permitting selection of a desired legacy code application,
process means for creating a legacy code instance in response to said selection;
environment means for defining a legacy code job environment; and
submission means for submitting a job for said desired legacy code application, together with information relating to said job environment, for submission to a job management means that arranges for said job to be executed on Grid resources.

2. A Grid management service according to claim 1, including list means for providing a list of available legacy code applications to the code selection means.

3. A Grid management service according to claim 2, including security credential means for qualifying said list in response to the credentials of an end user.

4. A Grid management service according to claim 3, wherein said security credential means includes means for authenticating an end user.

5. A Grid management service according to claim 1, wherein said environment means for defining a legacy code job environment includes, for at least one legacy code application, a file.

6. A Grid management service according to claim 5, wherein said file is expressed in XML.

7. A Grid management service according to claim 5, wherein said file includes a parameter section that specifies input and output user parameters.

8. A Grid management service according to claim 5, wherein said file includes an environment section defining at least one of: a job manager, maximum number of jobs allowed, a qualification on number of processors to be used

9. A Grid management service according to claim 5, including a respective file for each available legacy code application.

10. A Grid management service according to claim 1, wherein said process means includes means for creating a plurality of concurrent instances.

11. A Grid management service according to claim 1, including means for receiving the results of the execution of said job.

12. A Grid management service according to claim 1, including means for checking the status of said job.

13. A Grid management service according to claim 1, including Grid service client means that provides a user interface.

14. A Grid management service according to claim 5, wherein said process means includes a factory arranged for interacting with said file to define a default environment.

15. A Grid management service according to claim 1, wherein said information is provided in a file expressed in RSL.

16. A Grid management service according to claim 1, arranged as a three layer architecture comprising a front end layer that includes said selection means, a resource layer including said environment means, and a back end layer that includes at least part of said submission means, the back end layer being adapted to cooperate with standardised Grid services.

17. A method of providing legacy code applications as a Grid Service, the method comprising:
selecting a desired legacy code application, and creating, in response to the selection, a legacy code process instance;
defining a legacy code job environment, and
submitting a job for said desired legacy code application, together with information relating to said job environment, for submission to a job management means that arranges for said job to be executed on Grid resources.

18. A method according to claim 17, including providing a list of available legacy code applications for selection.

19. A method according to claim 18, including qualifying said list in response to security credentials of an end user.

20. A method according to claim 17, including authenticating an end user.

21. A method according to claim 17, including, as an initial step, providing a file defining a legacy code job environment.

22. A method according to claim 21, including, wherein said file is expressed in XML.

23. A method according to claim 21, wherein said file includes a parameter section that specifies input and output user parameters.

24. A method according to claim 21, wherein said file includes an environment section defining at least one of: a job manager, maximum number of jobs allowed, a qualification on number of processors to be used

25. A method according to claim 21, including a respective file for each available legacy code application.

26. A method according to claim 17, including creating a plurality of concurrent process instances.

27. A method according to claim 17, including receiving the results of the execution of said job.

28. A method according to claim 17, including checking the status of said job.

29. A method according to claim 17, including destroying said process instance.

30. A method according to claim 29, including cleaning said job environment.

31. A method according to claim 17, wherein said information is provided in a file expressed in RSL.
